(19) United States
(12) Patent Application Publication
(10) Pub. No.: US 2023/0401634 A1
(43) Pub. Date: Dec. 14, 2023

(54) PRODUCT CARD ECOMMERCE PURCHASE WITHIN SHORT-FORM VIDEOS

(71) Applicant: Loop Now Technologies, Inc., San Mateo, CA (US)

(72) Inventors: Di Wang, New York, NY (US); Jing Xian Chen, Dublin, CA (US); Jerry Ting Kwan Luk, Menlo Park, CA (US); Daniel Scott Rapaport, Redwood City, CA (US)

(73) Assignee: Loop Now Technologies, Inc., San Mateo, CA (US)

(21) Appl. No.: 18/208,933

(22) Filed: Jun. 13, 2023

Related U.S. Application Data
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.
(60) Provisional application No. 63/437,397, filed on Jan. 6, 2023.
(60) Provisional application No. 63/431,757, filed on Dec. 12, 2022.
(60) Provisional application No. 63/430,372, filed on Dec. 6, 2022.
(60) Provisional application No. 63/424,958, filed on Nov. 14, 2022.
(60) Provisional application No. 63/423,128, filed on Nov. 7, 2022.
(60) Provisional application No. 63/414,604, filed on Oct. 10, 2022.
(60) Provisional application No. 63/413,272, filed on Oct. 5, 2022.
(60) Provisional application No. 63/395,370, filed on Aug. 5, 2022.
(60) Provisional application No. 63/388,270, filed on Jul. 12, 2022.
(60) Provisional application No. 63/351,840, filed on Jun. 14, 2022.

(51) Int. Cl. G06Q 30/0601; G06Q 30/0251; G06Q 30/0207

(52) U.S. Cl. CPC G06Q 30/0643; G06Q 30/0635; G06Q 30/0253; G06Q 30/0222

(57) ABSTRACT

Techniques for video manipulation using a product card within a short-form video environment are disclosed. Display is accomplished using a video stream interface that can be executed on an electronic device associated with a user. The video stream, such as a short-form video or livestream video, can include one or more products. The display shows product cards associated with the products within the video. The product cards originate from a repository, a third-party website, or some other source. The product information includes text, video, and/or audio content. The user is provided an option to purchase one or more of the products presented within the video by selecting the product card. The viewer selects product cards displayed in front of the video to learn more about the products and/or purchase the products.

### RELATED APPLICATIONS

This application claims the benefit of U.S. provisional patent applications “Product Card Ecommerce Purchase Within Short-Form Videos” Ser. No. 63/351,840, filed Jun. 14, 2022, “Search Using Generative Model Synthesized Images” Ser. No. 63/388,270, filed Jul. 12, 2022, “Creating And Populating Related Short-Form Video Segments” Ser. No. 63/395,370, filed Aug. 5, 2022, “Object Highlighting In An Ecommerce Short-Form Video” Ser. No. 63/413,272, filed Oct. 5, 2022, “Dynamic Population Of Contextually Relevant Videos In An Ecommerce Environment” Ser. No. 63/414,604, filed Oct. 10, 2022, “Multi-Hosted Livestream In An Open Web Ecommerce Environment” Ser. No. 63/423,128, filed Nov. 7, 2022, “Cluster-Based Dynamic Content With Multi-Dimensional Vectors” Ser. No. 63/424,958, filed Nov. 14, 2022, “Text-Driven AI-Assisted Short-Form Video Creation In An Ecommerce Environment” Ser. No. 63/430,372, filed Dec. 6, 2022, “Temporal Analysis To Determine Short-Form Video Engagement” Ser. No. 63/431,757, filed Dec. 12, 2022, “Connected Television Livestream-To-Mobile Device Handoff In An Ecommerce Environment” Ser. No. 63/437,397, filed Jan. 6, 2023, “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, and “Immediate Livestreams In A Short-Form Video Ecommerce Environment” Ser. No. 63/464,207, filed May 5, 2023.

Each of the foregoing applications is hereby incorporated by reference in its entirety.

### FIELD OF ART

This application relates generally to short-form video manipulation and more particularly to product card ecommerce purchase within short-form videos.

### BACKGROUND

Video, music, and other types of media files are encoded and transmitted in sequential packets of data so they can be streamed instantaneously. Thus, the term “streaming” can refer to any media content, live or previously recorded, that is delivered to computers and mobile devices via a network communication protocol and played back in real time. Podcasts, webcasts, movies, TV shows, and music videos are common methods of streaming media content. Social media platforms and others broadcast everything from celebrity events, promotions, and livestreaming, to streaming between users. Streaming video can be viewed on a variety of compatible smartphones, tablets, TVs, and/or computer or gaming consoles with a relatively fast internet connection. Individuals are now able to consume video from almost anywhere on any connected device, at home, in the car, or even walking outside. Especially on mobile devices, social media platforms have become an extremely common use of internet-based video. These platforms can be accessed through the use of a browser or specialized app that can be downloaded. While these services vary in their video capabilities, they are generally able to display short video clips, repeating video “loops”, livestreams, music videos, etc. Countless hours are spent online watching an endless supply of videos from friends, family, social media influencers, gamers, favorite sports teams, or from a plethora of other sources.

The ability to produce and upload a short-form video quickly and easily has led to multiple outlets for videos made by professional production studios, interest groups, sales and marketing experts, social media influencers, and regular users of goods and services. All one needs is a modern cell phone with a built-in camera and microphone, and access to the Internet. While the quality of the videos may vary, even a poorly made video can have a huge impact on society. Real-time videos made of news events can be shot and transmitted around the world in minutes. Sports events can be watched and commented on as they occur by professionals and amateurs alike. Releases of new products and services can be covered by patrons as they complete their purchases or access amenities. The volume of short-form videos and the preference users have for them in many sectors of digital life has had a lasting impact on the way products are marketed, education is delivered, artforms are distributed, and personal communication is conducted. If a picture is worth a thousand words, surely a video is worth tens of thousands if not millions of words. Visual communication can be repeated all across the globe in just a few moments. And as the metaverse grows and becomes more accessible, video and its 3D cousins may well become even more important to our continuing world-wide conversation

### SUMMARY

Modern personal electronic devices, along with the development of the Internet, have enabled easy content creation, as well as efficient distribution of that content. A variety of Internet protocols, such as HTTP Live Streaming (HLS), Real-Time Messaging Protocol (RTMP), Web Real-Time Communications (WebRTC), and Secure Reliable Transport (SRT), to name a few, enable unprecedented amounts of video sharing. The videos can include news videos, educational videos, entertainment videos, how-to videos, as well as product discussion videos and/or product promotion videos.

Influencers and other content creators frequently discuss and/or review products in short-form videos. Disclosed embodiments enable streamlined ecommerce purchasing during such short-form videos via the use of a product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. When the product card is invoked, an additional on-screen display is rendered over a portion of the video while the video continues to play. This enables a user to purchase a product/service while preserving a continuous video playback session. In other words, the user is not redirected to another site or portal that causes the video playback to stop. Thus, users are able to initiate and complete a purchase completely inside of the video playback user interface, without being directed away from the currently playing video. Allowing the video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like. Most smartphones and tablets can operate in portrait mode (height is greater than width) or landscape mode (width is greater than height) simply by orienting the device appropriately. The portrait mode is becoming extremely popular for short-form video viewing, and thus, some embodiments are well suited to portrait mode (vertical orientation) operations.

A computer-implemented method for video manipulation is disclosed comprising: rendering a short-form video from a plurality of short-form videos delivered from a short-form video server; displaying a product card with a product representation, for a product, with the short-form video; adding the product displayed in the product card to a virtual purchase cart based on a user selection; collecting customer information, on a customer, within the virtual purchase cart; and completing an order for the product from the virtual purchase cart within an environment for the short-form video. In embodiments, displaying the product card is accomplished within a same window as the short-form video. Some embodiments comprise displaying a second product card with a second product representation with the short-form video. In embodiments, the environment for the short-form video is provided through a proprietary video service. In embodiments, the product card is selected from a plurality of product cards within the environment for the short-form video, and the selection of the product card is based on an average color of a region of the short-form video.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a product card ecommerce purchase with short-form videos.

FIG. 2 is a flow diagram for handling customer information in a product card ecommerce purchase.

FIG. 3 shows a product card ecommerce environment.

FIG. 4 shows a checkout user interface for a new customer.

FIG. 5 shows a checkout user interface for a recognized customer.

FIG. 6 is an example of a second purchase in a short-form video

FIG. 7 is an example order completion screen.

FIG. 8 is an example virtual cart display.

FIG. 9 is a system block diagram for a product card ecommerce purchase with short-form videos.

FIG. 10 is an example showing a product card with scaled video.

FIG. 11 shows an example of an L-shaped product card.

FIG. 12 is a system diagram for a product card ecommerce purchase with short-form videos.

### DETAILED DESCRIPTION

Techniques for video manipulation using a product card within a short-form video environment are disclosed. Display is accomplished using a video stream interface that can be executed on an electronic device associated with a user. The video stream, such as a short-form video, livestream video, etc., can include one or more products. The display can show product cards associated with the products within the video. The product cards can originate from a repository or a third-party website and can include text, video, audio content, and the like. The user (e.g., the viewer of the video) can purchase one or more of the products presented within the video by selecting the product card. The video that the viewer observes can be delivered from a short-form video server. The contents of the server can be provided by an individual, a team, a streaming service provider, and so on. The video stream can include a livestream video or livestream replay and can be displayed using a video player executing on a device. The video stream can be displayed within a frame, or a window associated with the video player. The displaying the video can be accomplished using an app, a window associated with a web browser, and the like. The video can contain one or more products. The viewer can select product cards displayed in front of the video to learn more about the products, to purchase the products, etc. The selected product can be added to a virtual purchase cart, wherein the virtual purchase cart can invoke a virtual shopping cart, a virtual shopping bag, a virtual tote, etc. A representation of the virtual purchase cart can be displayed while the viewer is viewing the short-form video. In embodiments, the virtual purchase cart is checked out upon termination of the short-form video. The termination can be based on the video streaming being terminated at the source, the user terminating the video streaming at the destination, and/or, an ending of a recorded video. Multiple purchases can be processed simultaneously upon termination of the short-form video in a batch order process, thereby saving computer resources such as network bandwidth.

Embodiments include displaying the product card within a same window as the short-form video, providing continuity for the user and enabling an improved user experience. Other embodiments include displaying a second product card with a second product representation with the short-form video. This is useful when a content creator is discussing multiple products during a short-form video. In such cases, each product can have its own corresponding product card. In embodiments, the short-form video is an advertisement. In some embodiments, the short-form video is an advertisement for the product. In some embodiments, the short-form video is an advertisement for products related to the product. In some embodiments, the short-form video is an advertisement for a category of products, wherein the product is contained within the category. In a usage example, the short-form video includes advertising a variety of household cleaning products, and the product corresponding to a displayed product card is also a household cleaning product. In embodiments, the advertisement conforms to Interactive Advertising Bureau requirements. These requirements can include sizing requirements, color requirements, shared library file size requirements, loading time requirements, and/or other relevant requirements.

Embodiments include rendering a short-form video from a plurality of short-form videos delivered from a short-form video server; displaying a product card with a product representation, for a product, with the short-form video; adding the product displayed in the product card to a virtual purchase cart based on a user selection; collecting customer information, on a customer, within the virtual purchase cart; and completing an order for the product from the virtual purchase cart within an environment for the short-form video.

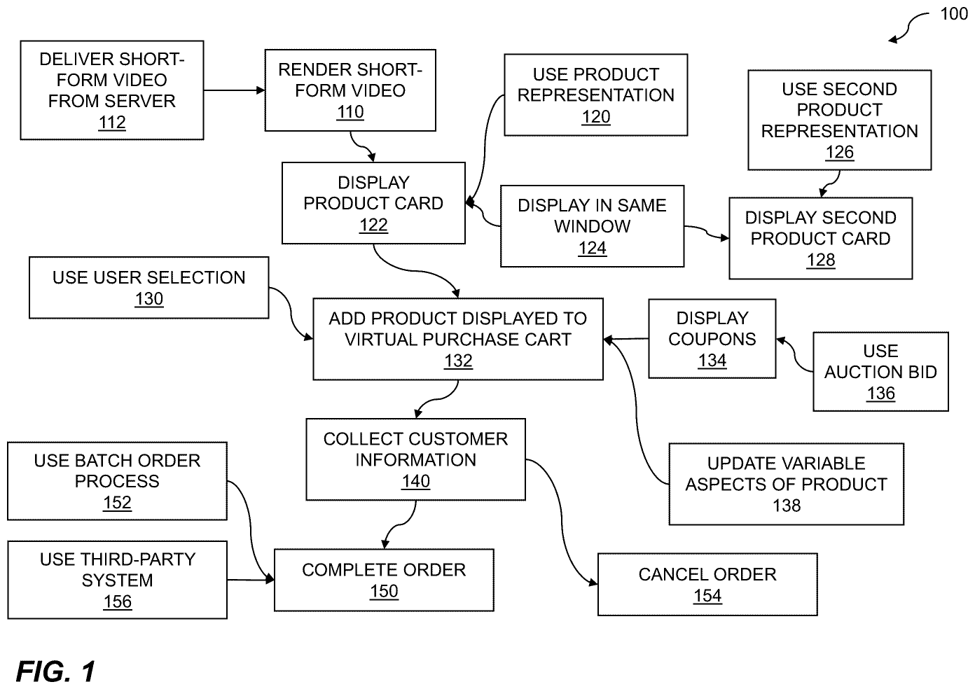

FIG. 1 is a flow diagram 100 for a product card ecommerce purchase with short-form videos. The flow includes rendering the short-form video 110. The rendering can include displaying decoded video frames on an electronic display, such as a screen of a smartphone or tablet, laptop or desktop computer, PDA, and so on. The short-form video can be delivered from a server 112. The delivery can be via any suitable network protocols, including, but not limited to, TCP, UDP, HTTP Live Streaming (HLS), Real-Time Messaging Protocol (RTMP), Web Real-Time Communications (WebRTC), Secure Reliable Transport (SRT), and/or other suitable protocols. The video can be delivered via unicast, multicast, or broadcast. In many cases, multicast is considered a one-to-many and many-to-many communication protocol that reduces network traffic when transmitting large amounts of data. Bandwidth optimization can occur because it delivers one single version of a data file, such as a livestream video, to hundreds or thousands of users simultaneously.

The flow includes using a product representation 120. The product representation 120 can include an image or video of the product, on-screen text and/or images, spoken words or other verbal utterances, metadata embedded within the user data of a video stream, etc. The flow 100 includes displaying a product card 122 based on the product representation. Embodiments include using natural language processing (NLP) to recognize speech and determine which product is being discussed in a short-form video. As a usage example, a host individual in a short-form video may say “and now I will demonstrate the XYZ blender.” Disclosed embodiments utilize the recognized speech to select and display a product card that corresponds to the product mentioned in the speech of the host individual (in this example, an XYZ blender). Embodiments include using computer-implemented image recognition through template matching and/or image classifiers with a machine learning system in order to identify products being discussed in a short-form video. Computer-implemented techniques can be used for performing entity detection as well as detecting a change in subject based on speech and/or actions of a host individual. The actions of the host individual can include picking up and/or moving a product. In embodiments, object tracking is utilized to assess how much the product is being moved around by the host individual. The amount of movement can be used as a criterion to determine that a product card corresponding to the product is to be displayed. The subject can include a particular product. The detecting a change in subject can include detecting a foreground object and identifying the foreground object as a product. The identification of the foreground product can include performing optical character recognition on text imprinted on a foreground object, and/or image recognition techniques. The identification of the foreground object as a product can include scanning an optical code such as a barcode that is imprinted on the product.

The flow 100 includes displaying one or more product cards in the same window 124. This allows the video to continue to play, with video and audio being output from an electronic device such as a smartphone, computer, tablet, etc., while the product card(s) are displayed. The flow includes using a second product representation 126. The second product representation 126 can include an image or video of the product, on-screen text and/or images, spoken words or other verbal utterances, metadata embedded within user data of a video stream, and so on. The flow includes displaying a second product card 128 corresponding to the second product representation 126. Thus, embodiments include displaying a second product card with a second product representation with the short-form video.

In some embodiments, the product card and second product card are displayed sequentially, where the product card is displayed for a period of time, then removed, and the second product card is then displayed for a period of time. In embodiments, detection of a transition to a second product (object) within a short-form video can be based on eye gaze of a host individual, information in an audio track of the short-form video, a detected subject matter change using machine learning based entity detection, a time interval, motion of a product, an action of a host individual, an action of a viewer, or some other criteria. When the detection of transition to a second product (object) occurs, the first product card can be removed, and the second product card is displayed. In other embodiments, the product card and second product card are displayed concurrently. The displaying a product card can be accomplished within a same window as the short-form video.

Product cards can be selected through a user selection 130. The user selection can include a swipe, press, mouse click, gesture, verbal utterance, or other suitable user action. Upon selection, additional information about the product can be displayed, and the flow includes adding the product displayed to a virtual purchase cart 132. The virtual purchase cart can hold one or more items. The virtual purchase cart can include a virtual shopping cart, a virtual shopping bag, a virtual tote, etc. In embodiments, adding a product includes enabling a display interaction with a representation for the product. The product can be represented by an icon or other image.

The flow can include displaying coupons 134. The coupons can include a quick response (QR) code, barcode, alphanumeric code, or other suitable indicia. In this way, product demonstrations and/or promotions within livestreams, livestream replays, and/or other short-form videos are enhanced. In some embodiments, the flow includes use of an auction bid 136 to determine which coupon(s) are displayed. The auctioning can be implemented via an online marketplace or other suitable ecommerce system. A variety of auction types can be utilized for auctioning of a coupon, and/or placement of a coupon. In some embodiments, an absolute auction, in which the highest bid wins regardless of price, is used. Other embodiments utilize a minimum bid auction, in which there is a minimum bid amount required before there can be a sale of a coupon placement (insertion opportunity). Other embodiments utilize a reserve auction, in which the seller can accept, reject, or counter the winning bid. Still other embodiments utilize a Dutch auction, in which the bidding for a coupon placement starts at a very high price and is progressively lowered until a buyer claims the coupon placement. A variety of other auction types can be used. In some embodiments, an auction can be entered by a potential buyer. Such a buyer could enter a bid and win a product purchase at the bid price. Further, in embodiments, a livestream replay can be rerun immediately after the livestream was recorded, shortly later, or even at a much later time than the original recording of the livestream. The livestream replay can be a direct rerunning of the livestream or can be an edited version of the livestream.

The flow includes updating variable aspects of the product 138. In embodiments, the adding includes the ability for the user to update quantity, price, size, color, or other variable aspects of a product. Some embodiments also include shipping options, so that users can select an appropriate shipping method for the item based on their needs and budget. The flow 100 can include collecting customer information 140. The customer information can include a phone number and/or email address, payment details including customer name, shipping address, credit card details, and an associated payment card address (if different from the shipping address). In some embodiments, the payment details include digital wallet information for support of purchases through cryptocurrencies such as Bitcoin and the like.

The flow includes order completion 150. The order completion can include charging the customer via the specified payment method (credit card, gift card, cryptocurrency, etc.), and/or processing the order for the product. The completing can also include finalizing a purchase of the product upon conclusion of the short-form video. The flow 100 also includes using a batch order process 152. In embodiments, when multiple items are purchased via product cards during the playback of a short-form video, the purchases are cached until termination of the video. The termination of the video can include the user stopping playback, the user exiting the video window, the livestream ending, or a prerecorded video ending. The batch order process 152 can enable a more efficient use of computer resources, such as network bandwidth, by processing the orders together as a batch. Prior to termination of the short-form video, the user can cancel orders 154 that were placed during the playing of the short-form video, which can include clearing/emptying a virtual purchase cart. Thus, embodiments include cancelling a purchase decision for the product within a duration for the short-form video.

The flow 100 can include using a third-party system 156 for the order processing. The third-party system can include an information source, a website, a search engine, an online retailer, and so on. The third-party system can include product information in the form of images, audio, text, videos, and the like. Further, the third-party system can include inventory information, estimated shipping costs, estimated fulfillment times, and other pertinent information that can be provided to the user. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

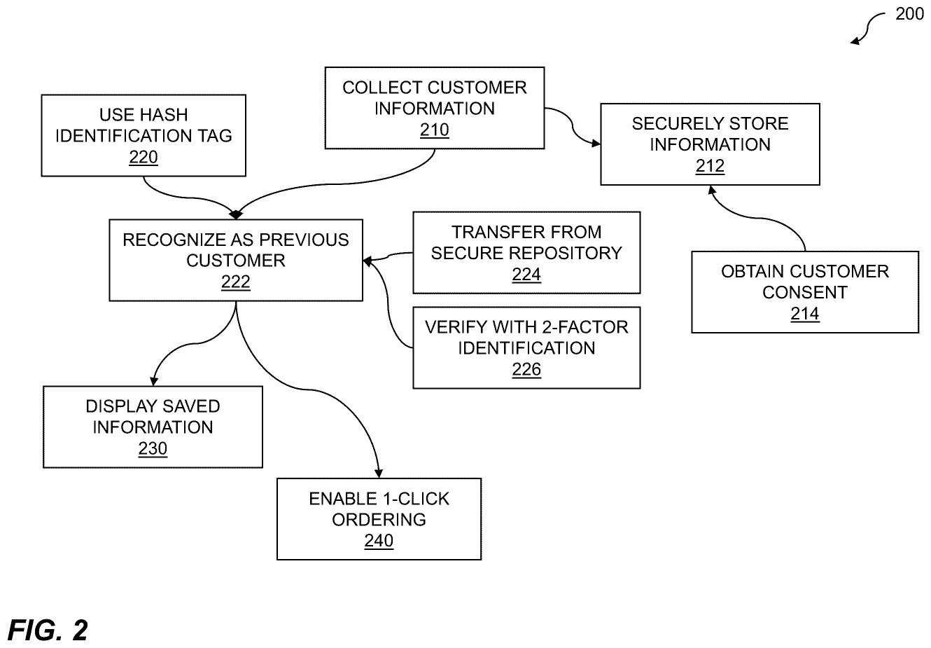

FIG. 2 is a flow diagram 200 for handling customer information in a product card ecommerce purchase. The flow 200 includes collecting customer information 210. The customer information can include, but is not limited to, phone number and/or email address, payment details including customer name, shipping address, credit card details, and an associated payment card address (if different from the shipping address). The payment details can include digital wallet information for support of purchases through cryptocurrencies such as Bitcoin and the like. The customer information can also include information from a social media system, and/or other profile information, including hobbies, interests, and other metadata that can enable intelligent selecting of product cards for display based on this information.

The flow 200 includes securely storing the customer information 212. The storing can include data replication which can be used to improve the availability of the data. In embodiments, the data replication includes transactional replication, snapshot replication, merge replication, and/or other suitable data replication techniques to ensure high availability of the customer information. The storing can include the use of disk encryption to protect the information while stored on one or more disks, which can include whole (full) disk encryption. In embodiments, the whole disk encryption utilizes a Trusted Platform Module (TPM) cryptographic chip. The flow 200 includes obtaining customer consent 214. The customer consent can include an “opt in” or other suitable customer agreement. The customer consent can include specifying which information is stored, how long it is kept, and which parties with whom the customer information can be shared.

The flow 200 can include using the hash identification tag 220. A hash of some or all of the customer information can be computed and stored. The hash can be computed via MD5, SHA256, or other suitable hashing technique and can be used as an identification tag. The hash tag can be used to recognize a customer as a previous customer 222. Thus, embodiments include recognizing the customer as a previous customer that completed a previous purchase. Other metadata can be used instead of, or in addition to, the hash tag for recognizing a customer as a previous customer. This can include, but is not limited to, a username, a user address, a phone number, an email address, a cookie managed by a browser, and the like. The stored information can include information for future purchases. The information can include updated shipping addresses, updated payment methods, and the like. Thus, in embodiments, the collecting includes securely storing customer information for future purchases.

The flow 200 includes transferring customer data from a secure repository 224. The transferring can include use of network encryption, such as an SSL (secure sockets layer), and/or other suitable transport layer security (TLS) to protect the information during transfer over a computer network. Thus, in embodiments, customer information is transferred from a secure repository within the environment for the short-form video as part of the collecting. The flow 200 can include verification with two-factor identification 226. In embodiments, the two-factor identification includes sending a code via SMS text message, email, or other application to an electronic device associated with a user, as part of a login process, purchase process, editing of customer information, and/or other aspects of an ecommerce session. Thus, in embodiments, the customer is verified based on two-factor identification. The flow 200 can include displaying saved customer information 230. In some embodiments, the user is provided an option to confirm and/or edit previously saved customer information. The flow 200 includes enabling one-click ordering 240. The one-click ordering can utilize the collected customer information. In this way, the user does not need to re-enter payment and/or shipping information. Various steps in the flow 200 can be changed in order, repeated, omitted, or the like without departing from the disclosed concepts. Various embodiments of the flow 200 can be included in a computer program product embodied in a non-transitory computer readable medium that includes code executable by one or more processors.

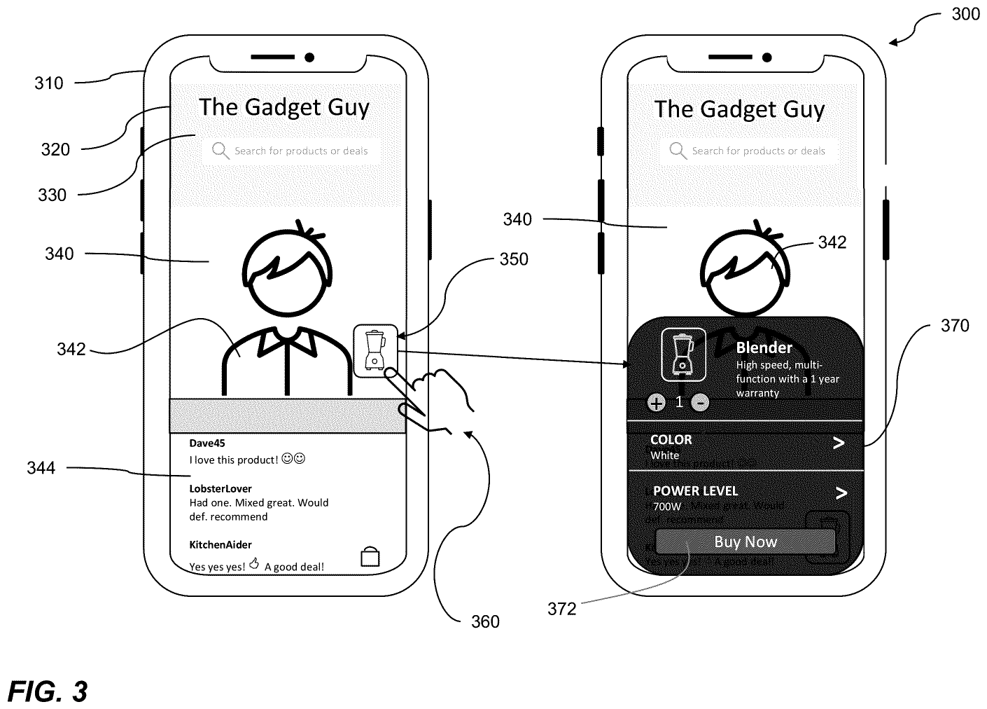

FIG. 3 shows a product card ecommerce environment 300. An electronic computing device 310 includes an electronic display 320. The device can include a handheld device such as a smartphone, PDA, or tablet; a portable device such as a laptop computer; a desktop computer; and so on. The electronic display can support an app such as a video player, web browser, and so on, that can render content which can include a video stream delivered from a server. The electronic display can also be a touchscreen to enable a user interface. An application, such as an HTML browser or other special purpose application 330, executes on the electronic computing device 310. A video region 340 can display a short-form video. The short-form video can include a host individual 342 who may discuss one or more products during the course of the short-form video. In embodiments, the short-form video comprises a livestream video or livestream video replay.

The application 330 can further include a chat window 344. The chat window can include comments and questions from viewers of the short-form video shown in the video region 340. A product card 350 is shown rendered over the video region 340. A user can select 360 the product card by a tap, click, mouse-over, gesture, etc. As a result, an expanded product card 370 is displayed. The expanded product card 370 is rendered in front of the video region 340, and the chat window 344. In some embodiments, the expanded product card 370 is rendered with translucency so that the short-form video can continue to be viewed behind the expanded product card 370. The expanded product card 370 includes product information. In this usage example, the product information includes specifications for a blender. The user can select certain options, such as color and/or quantity, and can add one or more products displayed into a virtual purchase cart. Thus, in embodiments, the adding includes the ability for the user to update quantity, price, size, color, or other variable aspects of a product. Additionally, in embodiments, the virtual purchase cart includes the ability for customers to modify or remove the one or more products added to the virtual purchase cart during the rendering of the short-form video.

While the extended product card 370 is displayed, the video continues to play. The extended product card can partially obscure the video region 340. A portion of the host individual 342 can still be visible. Thus, the user can continue to follow along with the video while making a purchase using the extended product card 370. When the user presses the “Buy Now” button 372, the one or more products are added to a virtual purchase cart. In some embodiments, customer information is already entered. The customer can be recognized as a previous customer and pressing the button 372 can result in one-click ordering of the product. Embodiments include enabling one-click ordering within the virtual purchase cart.

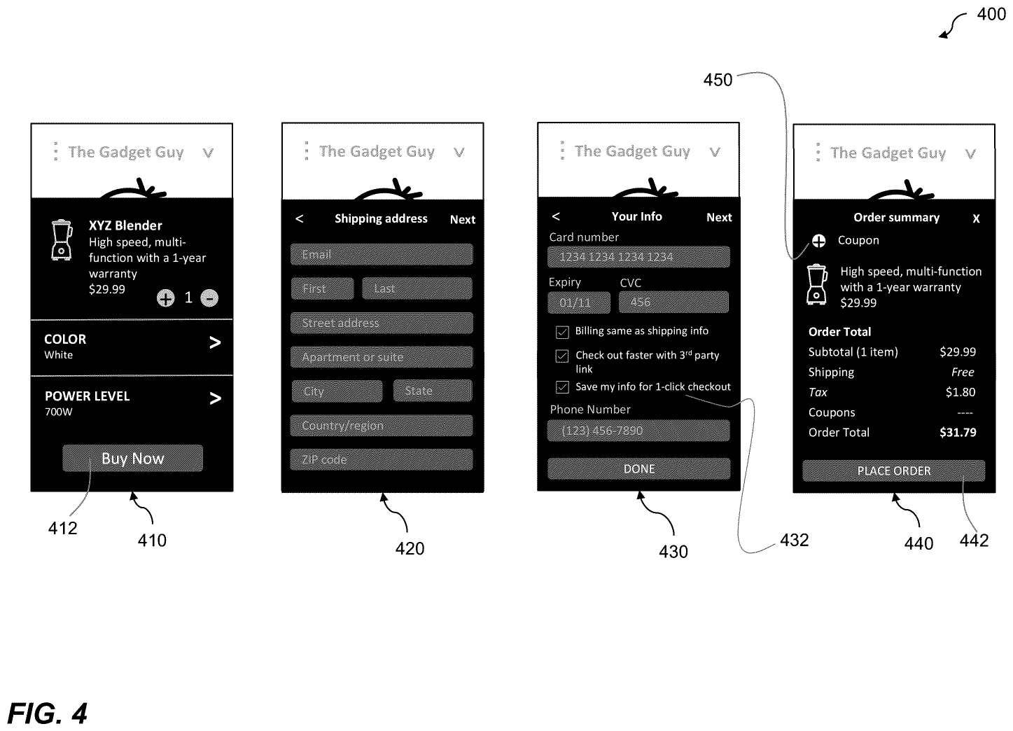

FIG. 4 shows a checkout user interface 400 for a new customer. At 410, a screen indicating an extended product card is shown. Upon invoking the “Buy Now” button 412, a shipping address user interface is shown at 420. Once the entry of information in the shipping user interface 420 is complete, the user experience transitions to the payment information user interface at 430. The payment information user interface 430 can include a consent field 432 to allow the user to consent to securely storing his/her information. Thus, in embodiments, the securely storing customer information is based on consent by the customer. Once the payment information entry is complete, the user interface transitions to the order confirmation user interface 440. Upon pressing the “Place Order” button 442, the order is placed, or queued for placement upon termination (completion) of the short-form video. In some embodiments, a coupon field 450 is present. The coupon field 450 can accept an alphanumeric code, a checkbox, or other suitable action for redeeming (“clipping”) a coupon.

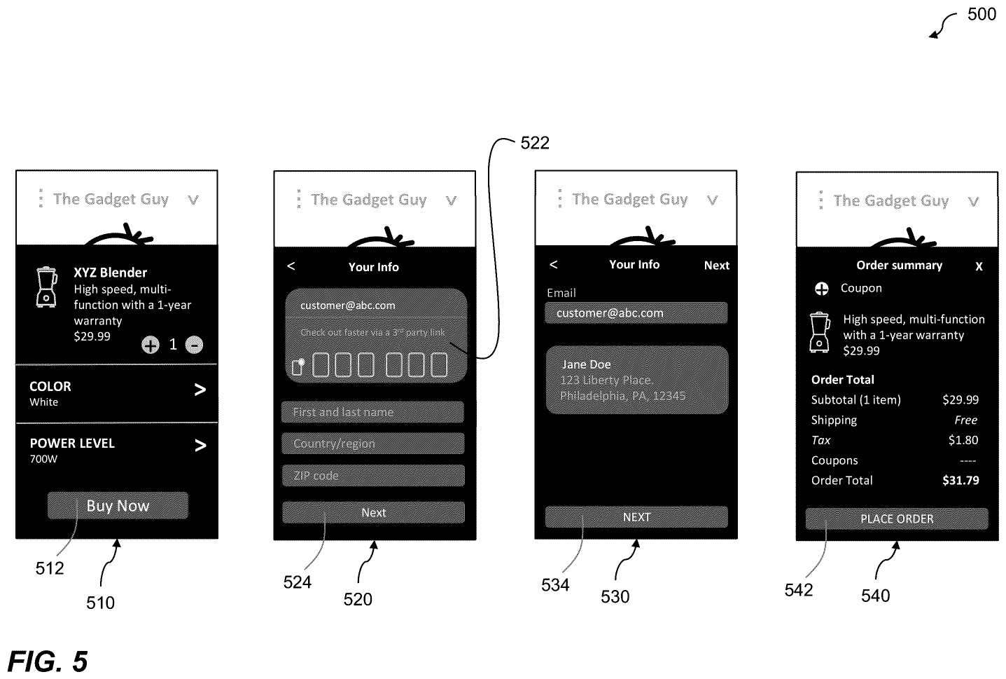

FIG. 5 shows a checkout user interface 500 for a recognized customer. Discussed above and throughout, a person viewing a video such as a short-form video can select one or more products included within the video. The selecting, which can be accomplished by tapping, clicking, swiping, mousing over, etc., adds the desired product to a virtual purchase cart. Products added to the virtual purchase cart can be purchased. If the user has “preregistered” prior to viewing the video, then the virtual purchase cart associated with the viewer is enabled. Enabling the virtual purchase cart by preregistration in turn allows the viewer to check out items within their virtual purchase cart using a “one-click” technique. Enabling the viewer's virtual purchase cart facilitates ecommerce purchase within a short-form video environment. A short-form video from a plurality of short-form videos delivered from a short-form video server is rendered. A product within the short-form video is selected. The product within the short-form video is added to a virtual purchase cart based on the selecting. A representation of the virtual purchase cart is displayed, wherein the representation is visible while viewing the short-form video. The virtual purchase cart is checked out. Contents of the virtual purchase cart are purchased. In embodiments, the purchase of the product is finalized upon conclusion of the short-form video.

An extended product card 510 shows product information, and a “Buy Now” button 512. Upon invoking the button 512, the customer information user interface 520 is rendered. The user can be asked to enter a code 522. The code can include an alphanumeric code and can be sent to the phone number or email address entered on the previous screen. Sending the code can be used to verify that the user has access to the provided phone number and/or email address. The user can enter the code and invoke the “next” button 524 to proceed to a customer information confirmation user interface 530. The user interface can include display of an email address, mailing address, telephone number, and/or other contact information. The user can edit the customer information. When/if the customer information is correct, the user can invoke the “next” button 534 to proceed to the order summary user interface 540. When the user invokes the “place order” button 542, the order is placed, or queued for placement upon termination of the short-form video.

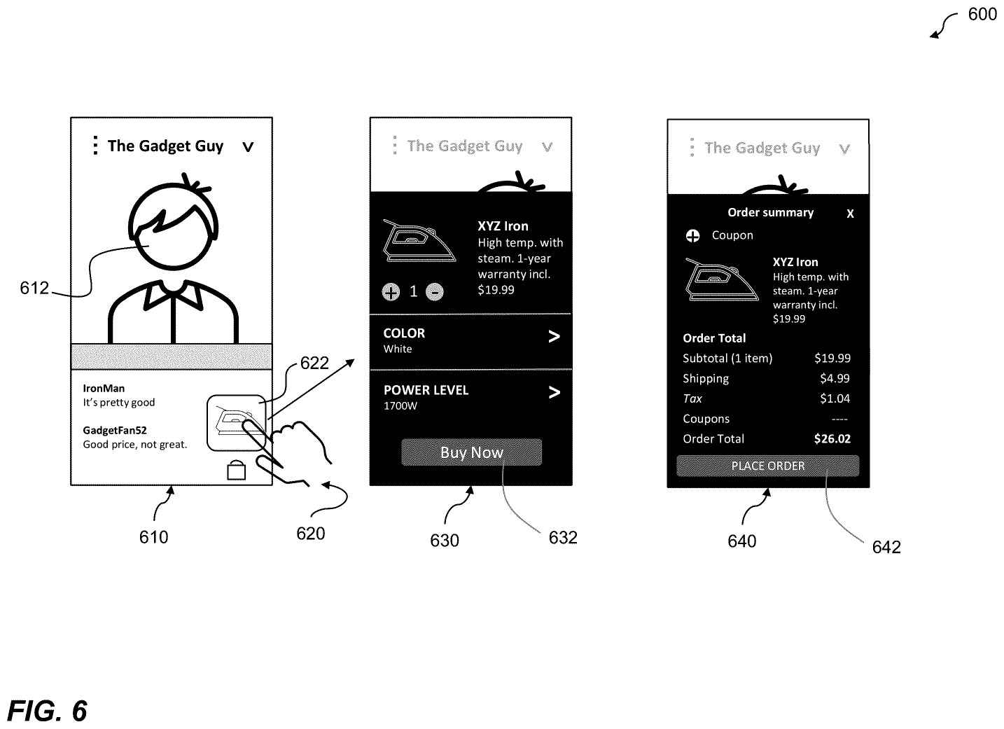

FIG. 6 is an example 600 of a second purchase in a short-form video. The example 600 is a continuation of the example depicted in FIG. 4 and FIG. 5. In FIG. 4, and FIG. 5, the product being referenced is a blender. In FIG. 6, the product is an iron as shown on the display screen 610. In a usage example, the host individual 612 may have stopped discussing the blender of FIG. 4 and FIG. 5 and begun discussing an iron. In embodiments, upon transitioning to a new subject, a new product card 622 for a second product is rendered.

When the user 620 taps, mouses over, gestures, etc. the product card 622, an expanded product card 630 is displayed. The user can use a finger, electronic pencil, etc. The expanded product card 630 includes product information. In this example, the product information includes specifications for a clothes iron. Additionally, the user can select certain options, such as color, quantity, and so on. While the extended product card 630 is displayed, the short-form video continues to play. When the user presses the “Buy Now” button 632, the product(s) are added to a virtual purchase cart. The user can then be directed to an order summary user interface 640. When the user invokes the “place order” button 642, the order is placed, or queued for placement upon termination of the short-form video. In embodiments, the customer is recognized for a second purchase during the same short-form video. This can save time for the second purchase since shipping information and payment method information can be reused from the previous purchase. Embodiments include finalizing a purchase of the product upon conclusion of the short-form video.

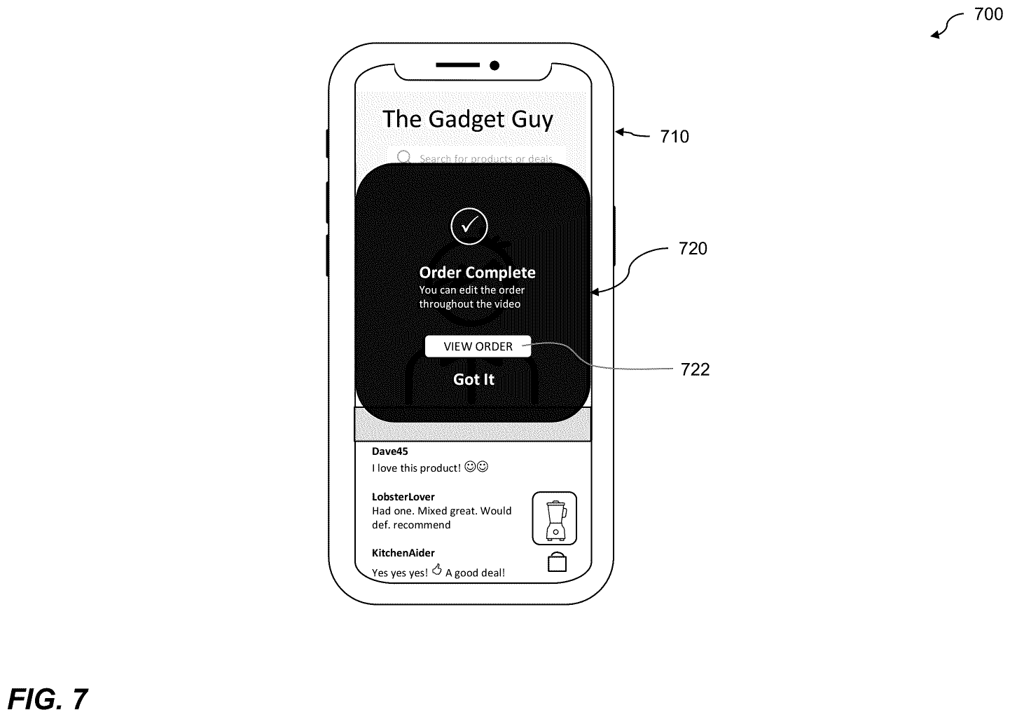

FIG. 7 is an example 700 of an order completion screen. In embodiments, the order completion screen is rendered on an electronic device 710 such as a smartphone, tablet, computer, and so on, and includes an order complete indication 720. The order complete indication can include a “view order” button 722 to view the order, virtual cart, and/or other purchase information. Thus, embodiments include displaying saved customer information in the virtual purchase cart.

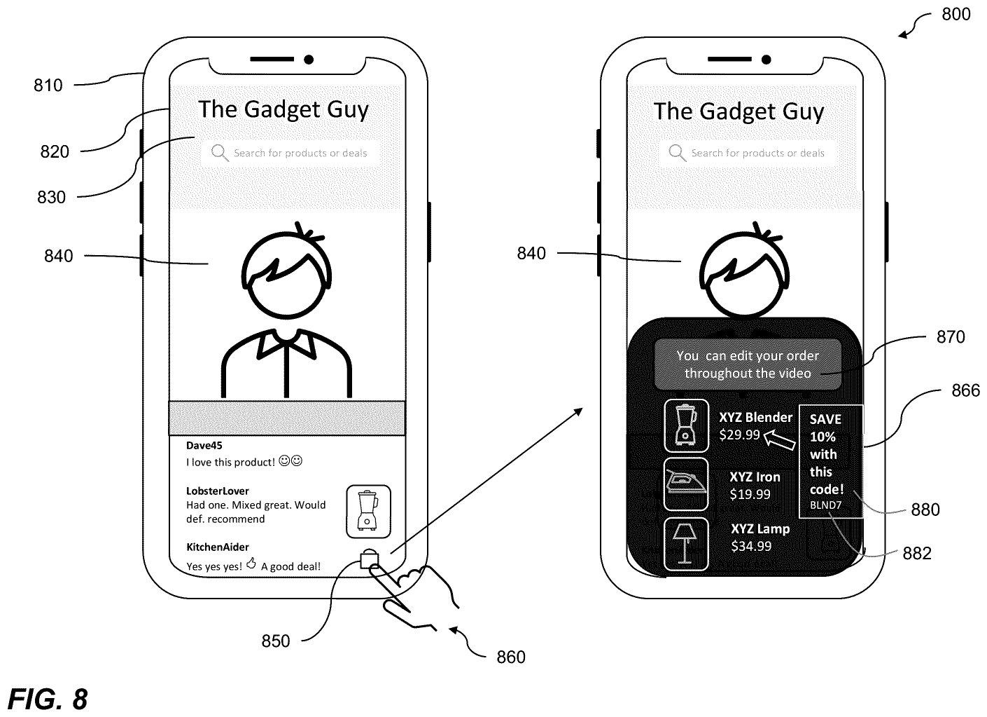

FIG. 8 is an example 800 of a virtual cart display. An electronic computing device 810 includes an electronic display 820. The device can include a handheld device such as a smartphone, PDA, or tablet; a portable device such as a laptop computer; a desktop computer; and so on. The electronic display 820 can support an app, such as a video player, web browser, and so on, that can render content. The content can include a video stream delivered from a server. In embodiments, the electronic computing device 810 is a smartphone. The electronic display 820 can also be a touchscreen, which enables a user interface. An application, such as an HTML browser or other special purpose application 830, executes on the electronic computing device 810. A video region 840 can display a short-form video. A cart icon 850 can be displayed on the electronic display 820. When the user 860 presses or otherwise invokes the cart icon 850 with a finger, pointer, electronic pencil, etc., a virtual cart 866 is displayed while the video continues to play in region 840. In some embodiments, the virtual cart 866 partially obscures the video region 840. In some embodiments, the displaying of the virtual purchase cart occupies a portion of a display screen while the short-form video occupies another portion of the display screen. A portion of the short-form video can be displayed, where a remaining portion of the short-form video is covered by the virtual purchase cart. In some embodiments, the virtual purchase cart is partially transparent showing the short-form video portion being covered. This can be accomplished via alpha-blending, setting a translucency field for the virtual purchase cart, and so on. A graphics compositor within device 810 can perform compositing and/or blend operations to enable a translucent virtual purchase cart. In this way, the virtual purchase cart can be viewed while the video can also be seen behind the virtual purchase cart.

The virtual cart 866 can include a button 870 to enable editing of the virtual cart. The editing can include adding an item, deleting an item, adjusting a quantity of an item, and/or other virtual cart operations. In embodiments, the environment for the short-form video displays the virtual purchase cart while the short-form video plays. The virtual purchase cart can cover a portion of the short-form video. In some embodiments, the virtual purchase cart includes one or more coupons 880. The coupons can be indicated for one of the products in the virtual purchase cart. The coupons 880 can include an alphanumeric code 882. Entering the alphanumeric code in a user interface field can allow the coupon to be redeemed (“clipped”). Thus, embodiments include displaying one or more coupons for the at least one product selected in the virtual purchase cart. The one or more coupons can be presented based on an auction bid. In embodiments, the virtual purchase cart includes the ability to clip coupons. The clipping of coupons can include entering a code into a field, selecting a checkbox, or completing some other suitable action on the user interface.

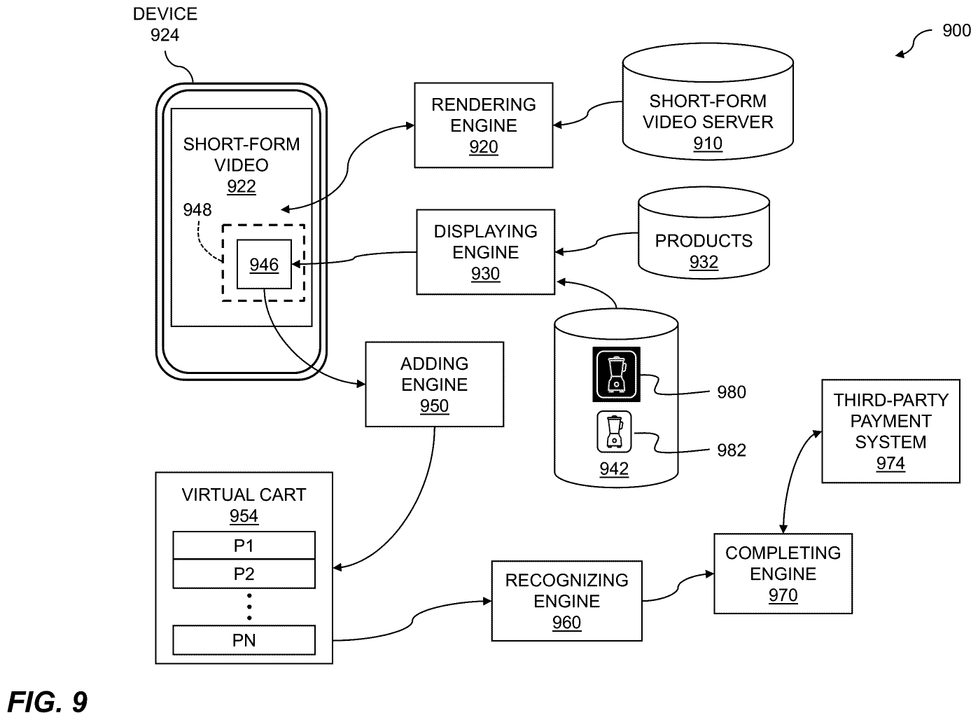

FIG. 9 is a system block diagram 900 for a product card ecommerce purchase environment with short-form videos. The system block diagram 900 can include a short-form video server 910. The short-form video server can include a local server, a remote server, a cloud server, a distributed server, and so on. The short-form video server can deliver a short-form video from a plurality of short-form videos. The short-form videos stored on the server can be uploaded by individuals, content providers, influencers, tastemakers, and the like. The short-form videos can be rendered by the rendering engine 920. The rendering engine 920 can include one or more video codecs which can be implemented in special purpose integrated circuits, or implemented in software on general purpose processors and/or graphics processing units (GPUs). The video codecs can include H.264, H.265, MPEG-4, and/or other suitable codecs. The output of the rendering engine 920 can be displayed as a short-form video 922 on electronic device 924. In embodiments, a short-form video unit can contain a checkout component and can be packaged for distribution to an open web. In this manner, the short-form video can be displayed on a publisher site. In some cases, the publisher site has no direct connection to an actual merchant site. The ad exchange would be facilitated using a specific IAB format. In this case, a buyer completes checkout for the specific product on a publisher site, using an advertisement proprietary video unit, without needing to visit the actual ecommerce site. The ecommerce merchant can then receive order information from the proprietary video unit to fulfill the order to the buyer per usual.

The system block diagram 900 can include one or more lists of products 932. The system block diagram 900 can further include a product card database 942. The product card database 942 can contain one or more product card records corresponding to a product. The product card records can include a graphical image, as well as additional metadata that can include, but is not limited to a model number, a part number, a manufacturer, a size, a color, and/or other product specific information. In embodiments, the product card is selected from a plurality of product cards within the environment for the short-form video. The displaying engine 930 can obtain a product 932 and retrieve one or more product cards corresponding to that product from product card database 942. The displaying engine 930 can display a product card 946 over a region 948 of the short-form video 922.

The system block diagram 900 can include an adding engine 950 which obtains a signal or message when the product card 946 is invoked (e.g., via a user pressing it), and updates a virtual cart 954 accordingly. The system block diagram 900 can include a recognizing engine 960. The recognizing engine can utilize metadata, such as customer name, address, username, phone number, email address, and/or other data, to identify previous customers. Previous customers can be recognized by a hash identification tag. In some embodiments, a hash of some or all of the customer information is computed and stored. The hash can be computed via MD5, SHA256, or some other suitable hashing technique. In embodiments, the hash is used as an identification tag to recognize a return customer. Using a hash to confirm a previous customer can be more efficient than comparing multiple data fields such as name and address, since only one comparison is needed when checking a match of a hash. By recognizing return customers, orders can be processed more efficiently in cases where previously entered payment and shipping information can be reused for the current transaction. In embodiments, collecting customer information within the virtual purchase cart is accomplished based on a previous purchase by the customer.

The system block diagram 900 can include a completing engine 970. The completing engine can interface with a third-party payment system 974, payment processing system, and/or order fulfillment system to finalize the transaction. In embodiments, the completing includes an ability to connect to a third-party payment system. In some embodiments, the completing engine 970 completes the transaction upon termination of short-form video 922. In this way, in cases where the user decides to purchase additional items/services showcased in short-form video 922, multiple purchases can be processed simultaneously upon termination of the short-form video in a batch order process, thereby saving computer resources such as network bandwidth. Thus, in embodiments, the finalizing is accomplished using a batch order process.

In embodiments, the selection of the product card is based on an average color of a region of the short-form video. As shown in FIG. 9, product card 980 and product card 982 are both for a blender. Product card 980 is an inverse color image of product card 982. In embodiments, a video analysis of region 948 is performed to determine an average color within region 948. Based on the average color, a product card that has the most contrast with the average color is selected. In a usage example, if the video in region 948 is dark (black, dark gray, dark brown, etc.), then the light outline product card indicated at 982 can be selected. Conversely, if the video in region 948 is light (white, yellow, pink, etc.), then the dark outline product card indicated at 980 can be selected. In this way, an improved user experience can be provided.

The rendering engine 920, the displaying engine 930, the adding engine 950, the recognizing engine 960, and the completing engine 970 can each be implemented using one or more processors that execute machine instructions retrieved from a non-transitory computer readable medium. The processors can be coupled to one or more network interfaces for communication over a computer network, such as a local-area network, wide-area network, and/or the Internet. In embodiments, the environment for the short-form video is provided through a proprietary video service.

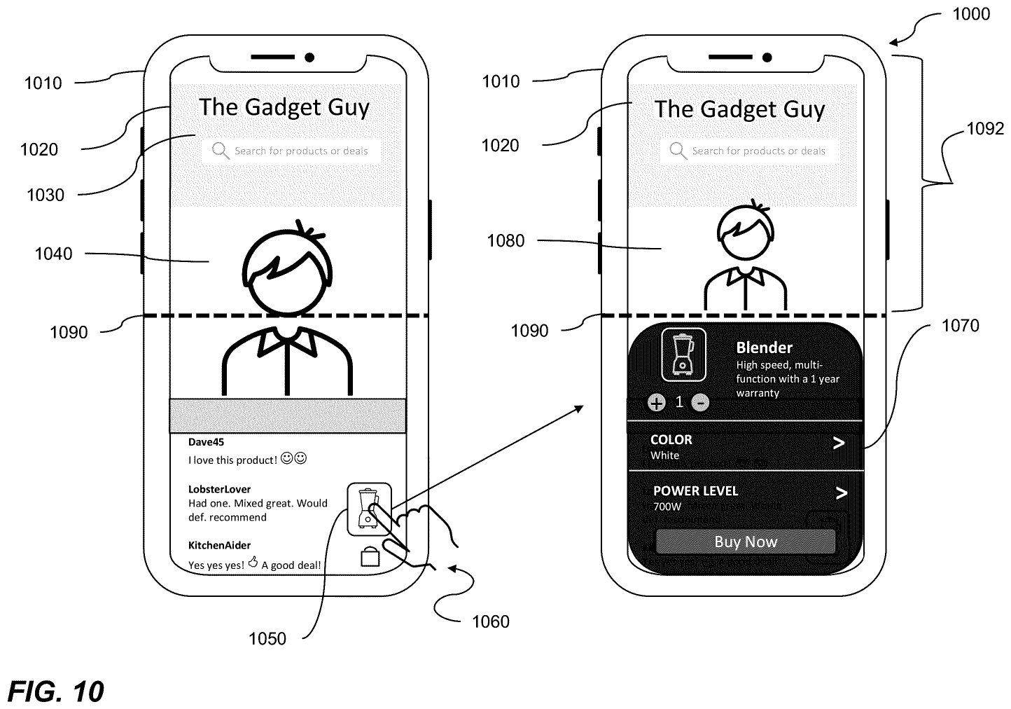

FIG. 10 is an example 1000 showing a product card with scaled video. An electronic computing device 1010 includes an electronic display 1020. The device can include a handheld device such as a smartphone, PDA, or tablet; a portable device such as a laptop computer; a desktop computer; and so on. The electronic display 1020 can support an app such as a video player, web browser, and so on, that can render content. The content can include a video stream delivered from a server. In embodiments, the electronic computing device 1010 is a smartphone. The electronic display 1020 can also be a touchscreen, to enable a user interface. An application, such as an HTML browser or other special purpose application 1030, executes on the electronic computing device 1010. A video region 1040 can display a short-form video.

A product card 1050 is shown rendered on electronic display 1020. When the user 1060 presses, taps, swipes, gestures, etc. the product card 1050, an expanded product card 1070 is displayed. The user can indicate the selection with a finger, pointer, electronic pencil, etc. The expanded product card 1070 is rendered on the electronic display 1020. The expanded product card 1070 includes product information. In this example, the product information includes specifications for a blender. Additionally, the user can select certain options, such as color and/or quantity. While the extended product card 1070 is displayed, the video continues to play. In this embodiment, a scaled video window 1080 is rendered, where the scaled video window 1080 is smaller than the original video window 1040. In this way, the short-form video continues to play and render without being obscured while the expanded product card 1070 is being displayed. This can create an improved user experience as the continuity of the video experience is preserved and the video remains completely visible during the shopping and checkout process. In embodiments, the short-form video is shrunk so that the whole video window is shown in the portion of the display screen showing the short-form video. Other display techniques to show the representation of the card can be used. The short-form video can be partially covered by the representation of the card. In some embodiments, the card is partially transparent, etc.

Some electronic devices, such as certain smartphones, are foldable. A foldable smartphone can utilize Flexible Display (FD) technology. FD technology can include Organic Light Emitting Diode (OLED) screens. OLED screens are made of organic materials that emit light when electricity is passed through them. They do not require backlights to function, and as a result, can be made thin enough to the point where they become flexible, and can form the basis of flexible screens. Electronic computing device 1010 can use FD technology as well as other screen technologies that enable folding, with a fold line indicated at 1090. Thus, the electronic computing device 1010 is capable of folding along line 1090 to achieve improved portability. A foldable region 1092 indicates a portion of the electronic display 1020 that is planar while the electronic device 1010 is in a folded configuration. In embodiments, the scaled video window 1080 is scaled to fit within a foldable region 1092 of electronic device 1010 when the expanded product card 1070 is invoked.

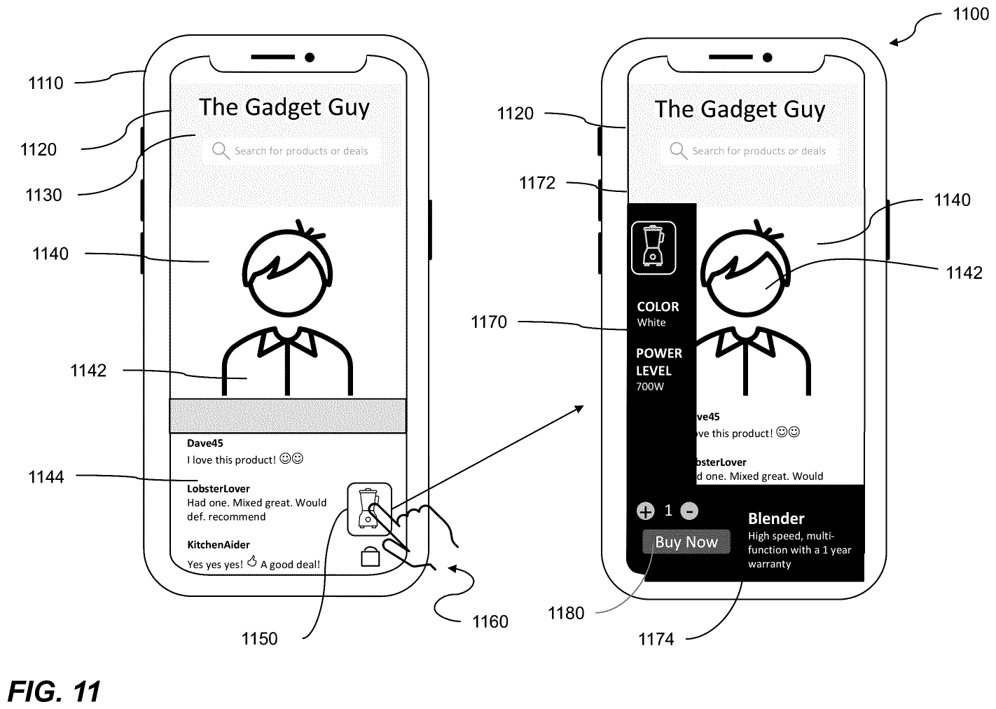

FIG. 11 shows an example 1100 of an L-shaped product card. An electronic computing device 1110, shown in FIG. 11 as oriented in portrait mode, includes an electronic display 1120. The device can include a handheld device such as a smartphone, PDA, or tablet; a portable device such as a laptop computer; a desktop computer; and so on. The electronic display 1120 can support an app such as a video player, web browser, and so on, that can render content. The content can include a video stream delivered from a server. In embodiments, the electronic computing device 1110 is a smartphone. The electronic display 1120 can also be a touchscreen, to enable a user interface. An application, such as an HTML browser or other special purpose application 1130, executes on the electronic computing device 1110. A video region 1140 can display a short-form video. The short-form video can include a host individual 1142 who may discuss one or more products during the course of the short-form video. In embodiments, the short-form video includes information on the product.

The application 1130 can further include a chat window 1144. The chat window 1144 can include comments and questions from viewers of the short-form video shown in video region 1140. A product card 1150 can be rendered on the display 1120. When the user 1160 taps, swipes, gestures, etc. the product card 1150, an expanded product card 1170 is displayed. The user can indicate the selection with a finger, pointer, electronic pencil, etc. The expanded product card 1170 can be L-shaped, with a portion disposed along a side 1172 of the electronic display 1120, and a portion rendered along the bottom 1174 of display 1120. The L-shaped product card can be conducive to portrait mode orientations. When a screen is in portrait mode, its length is greater than its width. The portrait mode is becoming extremely popular for short-form video viewing. The embodiment shown in FIG. 11 is well suited to portrait mode operations. Embodiments include display of an advertisement. In embodiments, the advertisement is oriented vertically for display on a mobile device.

The expanded product card 1170 is rendered in front of the video region 1140, and the chat window 1144. The expanded product card 1170 includes product information. In this example, the product information includes specifications for a blender. Additionally, the user can select certain options, such as color and/or quantity. While the extended product card 1170 is displayed, the video continues to play. The extended product card can partially obscure the video region 1140. A portion of the host individual 1142 can still be visible. Thus, the user can continue to follow along with the video while making a purchase using the extended product card 1170. When the user presses the “Buy Now” button 1180, one or more selected products can be added to a virtual purchase cart. In some embodiments, the customer information is already entered. In this case, the customer can be recognized as a previous customer, and pressing the button 1180 can result in one-click ordering of the product. In some embodiments, product card 1170 is the initially displayed product card and has not been transitioned from product card 1150 to product card 1170. Thus, product card 1170 can serve as an initial product card, or an expanded product card. In embodiments, the product card is an L-shaped product card.

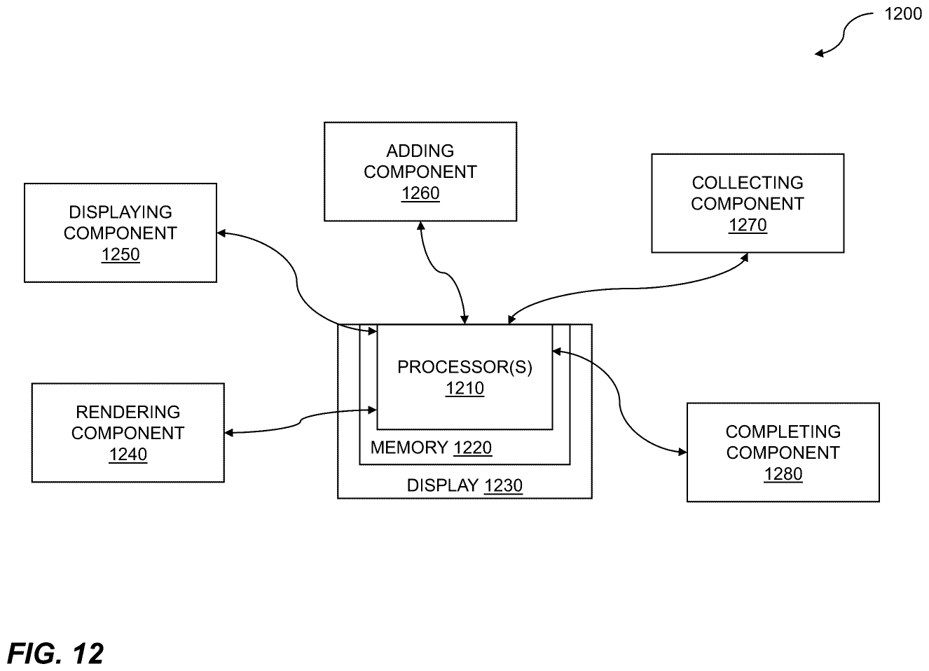

FIG. 12 is a system diagram for a product card ecommerce purchase with short-form videos. Video manipulation utilizing a product card within a short-form video is enabled by the system depicted in FIG. 12. The short-form video can include a prerecorded video, a livestream video, and so on. The system 1200 can include one or more processors 1210 coupled to a memory 1220 which stores instructions. The system 1200 can include a display 1230 coupled to the one or more processors 1210 for displaying data, video streams, videos, product information, virtual purchase cart contents, webpages, intermediate steps, instructions, and so on. In embodiments, one or more processors 1210 are coupled to the memory 1220 where the one or more processors, when executing the instructions which are stored, are configured to: render a short-form video from a plurality of short-form videos delivered from a short-form video server; display a product card with a product representation, for a product, with the short-form video; add the product displayed in the product card to a virtual purchase cart based on a user selection; collect customer information, on a customer, within the virtual purchase cart; and complete an order for the product from the virtual purchase cart within an environment for the short-form video.

The system 1200 can include a rendering component 1240. The rendering component 1240 can include functions and instructions for rendering a short-form video from a plurality of short-form videos delivered from a short-form video server. The rendering can be accomplished using a user interface such as a web browser, a video player app, a specialty app provided by a vendor or service, etc. The rendering of the short-form video can be accomplished on a variety of electronic devices. In embodiments, the rendering can be accomplished on a mobile device, a computer such as a laptop computer or desktop computer, and so on. The short-form video that is rendered by the user interface can include a variety of video types. In embodiments, the short-form video includes a livestream video. The livestream video can be presented by an enterprise, a celebrity, a promoter, etc. A livestream video stream can be created by and can originate from a variety of individuals who can include a tastemaker, an influencer, an artist, a musician, a DJ, an individual with content she or he wants to share, a provider of a good or service, and so on. The video stream can include content such as one or more products. The products can include items that the creator uses, recommends, promotes, endorses, and so on. The products can include various goods. In embodiments, the product includes a service. In other embodiments, the product includes a coupon or a membership. The short-form video can include a curated stream, videos from a streaming website, a video server, social media or other shared sites, and the like. The video stream can include a recorded message, a livestream video, a previously recorded livestream video, etc. A short-form video can include a video that displays for 30 seconds, 2.5 minutes, fewer than 10 minutes, and the like. In embodiments, the rendering the short-form video and products within the video is accomplished without a popup window.

The system 1200 can include a displaying component 1250. The displaying component 1250 can include functions and instructions for displaying one or more product cards. The displaying of the product cards can be based on a product being discussed in a short-form video, a product that is related to a product being discussed in a short-form video, or image characteristics of a video region. The image characteristics can include, but are not limited to, brightness, contrast, color, and/or other image characteristics. In embodiments, the image characteristics are used to select a product card that has optimal visibility to improve noticeability of the product card, thereby increasing opportunities for sales of the corresponding product.

The system 1200 can include an adding component 1260. The adding component 1260 can include functions and instructions for adding products to a virtual purchase cart based on user interaction with the product cards displayed by the displaying component. The adding component 1260 can utilize APIs including a subscription mechanism for getting notifications when some changes or events on shopping carts occur. The notifications can be in the form of a callback function. In a usage example, an order status callback can be triggered whenever an order status changes. In some embodiments, the triggering includes JSON formatted data being sent to a specified URL. Other embodiments include utilization of RESTful APIs, and/or other suitable protocols and techniques for interacting with third-party ecommerce systems and/or order fulfillment systems.

The system 1200 can include a collecting component 1270. The collecting component 1270 can include functions and instructions for collecting customer information. The customer information can include name, shipping address, email address, phone number, account number, and/or other relevant data. In some embodiments, a hash of the customer data is performed for use as an identification tag to identify returning customers.

The system 1200 can include a completing component 1280. The completing component 1280 can include functions and instructions for completing a transaction. The completing component 1280 can utilize APIs including a subscription mechanism for getting notifications when some changes or events on shopping carts occur. The notifications can be in the form of a callback function. In a usage example, an order status callback can be triggered whenever an order status changes. In some embodiments, the triggering includes JSON formatted data being sent to a specified URL. Other embodiments include utilization of RESTful APIs, and/or other suitable protocols and techniques for interacting with third-party ecommerce systems and/or order fulfillment systems.

The completing component 1280 can utilize a batch order process. In embodiments, when multiple items are purchased via product cards during the playback of a short-form video, the purchases are cached until termination of the video. The termination (completion) of the video can include the user stopping playback, the user exiting the video window, the livestream ending, or a prerecorded video ending. The batch order process can enable a more efficient use of computer resources, such as network bandwidth, by processing the orders together as a batch.

The system 1200 can include a computer program product embodied in a non-transitory computer readable medium for video manipulation, the computer program product comprising code which causes one or more processors to perform operations of: rendering a short-form video from a plurality of short-form videos delivered from a short-form video server; displaying a product card with a product representation, for a product, with the short-form video; adding the product displayed in the product card to a virtual purchase cart based on a user selection; collecting customer information, on a customer, within the virtual purchase cart; and completing an order for the product from the virtual purchase cart within an environment for the short-form video.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions-generally referred to herein as a “circuit,” “module,” or “system” may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video manipulation comprising:
rendering a short-form video from a plurality of short-form videos delivered from a short-form video server;
displaying a product card with a product representation, for a product, with the short-form video;
adding the product displayed in the product card to a virtual purchase cart based on a user selection;
collecting customer information, on a customer, within the virtual purchase cart; and
completing an order for the product from the virtual purchase cart within an environment for the short-form video.

2. The method of claim 1 wherein displaying the product card is accomplished within a same window as the short-form video.

3. The method of claim 2 further comprising displaying a second product card with a second product representation with the short-form video.

4. The method of claim 1 wherein the environment for the short-form video is provided through a proprietary video service.

5. The method of claim 1 wherein the short-form video includes information on the product.

6. The method of claim 1 wherein the product card is selected from a plurality of product cards within the environment for the short-form video.

7. The method of claim 6 wherein the selection of the product card is based on an average color of a region of the short-form video.

8. The method of claim 1 wherein the short-form video is an advertisement.

9. The method of claim 8 wherein the short-form video is an advertisement for the product, for products related to the product, or for a category of products, wherein the product is within the category.

10. The method of claim 1 wherein the product card is an L-shaped product card.

11. The method of claim 1 wherein the environment for the short-form video displays the virtual purchase cart while the short-form video plays.

12. The method of claim 11 wherein the virtual purchase cart covers a portion of the short-form video.

13. The method of claim 1 wherein the collecting customer information within the virtual purchase cart is accomplished based on a previous purchase by the customer.

14. The method of claim 13 wherein the customer information is transferred from a secure repository within the environment for the short-form video as part of the collecting.

15. The method of claim 1 wherein the collecting includes securely storing customer information for future purchases.

16. The method of claim 15 further comprising recognizing the customer as a previous customer that completed a previous purchase.

17. The method of claim 1 wherein the adding includes an ability for the user to update quantity, price, size, color, or other variable aspects of a product.

18. The method of claim 1 wherein the virtual purchase cart includes the ability for customers to modify or remove the product added to the virtual purchase cart during the rendering of the short-form video.

19. The method of claim 1 wherein the completing includes finalizing a purchase of the product upon conclusion of the short-form video.

20. The method of claim 19 further comprising cancelling a purchase decision for the product within a duration for the short-form video.

21. The method of claim 19 further comprising displaying one or more coupons, for the product selected, in the virtual purchase cart.

22. The method of claim 21 wherein the one or more coupons are presented based on an auction bid.

23. The method of claim 19 wherein the virtual purchase cart includes an ability to clip coupons.

24. The method of claim 1 wherein the displaying of the virtual purchase cart occupies a portion of a display screen while the short-form video occupies another portion of the display screen.

25. The method of claim 24 wherein a portion of the short-form video is displayed, wherein a remaining portion of the short-form video is covered by the virtual purchase cart.

26. The method of claim 25 wherein the virtual purchase cart is partially transparent showing a short-form video portion being covered.

27. A computer program product embodied in a non-transitory computer readable medium for video manipulation, the computer program product comprising code which causes one or more processors to perform operations of:
rendering a short-form video from a plurality of short-form videos delivered from a short-form video server;
displaying a product card with a product representation, for a product, with the short-form video;
adding the product displayed in the product card to a virtual purchase cart based on a user selection;
collecting customer information, on a customer, within the virtual purchase cart; and
completing an order for the product from the virtual purchase cart within an environment for the short-form video.

28. A computer system for video manipulation comprising:
a memory which stores instructions;
one or more processors coupled to the memory wherein the one or more processors, when executing the instructions which are stored, are configured to:
render a short-form video from a plurality of short-form videos delivered from a short-form video server;
display a product card with a product representation, for a product, with the short-form video;
add the product displayed in the product card to a virtual purchase cart based on a user selection;
collect customer information, on a customer, within the virtual purchase cart; and
complete an order for the product from the virtual purchase cart within an environment for the short-form video.
